(19) United States
(12) Patent Application Publication
(10) Pub. No.: US 2018/0150966 A1
(43) Pub. Date: May 31, 2018

(54) SYSTEM AND METHOD FOR ESTIMATING OBJECT SIZE

(71) Applicant: ASELSAN ELEKTRONIK SANAYI VE TICARET ANONIM SIRKETI, Ankara (TR)

(72) Inventor: Erdem Akagunduz, Ankara (TR)

(73) Assignee: ASELSAN ELEKTRONIK SANAYI VE TICARET ANONIM SIRKETI, Ankara (TR)

(21) Appl. No.: 15/880,542

(22) Filed: Jan. 26, 2018

Related U.S. Application Data
(63) Continuation-in-part of application No. 14/364,511, filed on Sep. 22, 2014.

(51) Int. Cl. G06T 7/62

(52) U.S. Cl. CPC G06T 7/62; G06T 2207/10048; G06T 2207/20101; G06T 2207/20021; G06T 2207/20072

(57) ABSTRACT

A system and a method for estimating a size of an object in an image are provided. The method is implemented on images captured and processed by an image processor for increasing the efficiency and quality of the estimation of an object size in the image. The method includes at least following steps: providing a pixel image including at least one object and selecting a pixel on the object; calculating pixel standard deviations for pixels lying within an increasing window, to generate a graph of window size versus standard deviation; checking whether a curve of the graph of window size versus standard deviation represents a monotonically decreasing trend or not.

### CROSS REFERENCE TO RELATED APPLICATIONS

This application is a continuation in part application of U.S. patent application Ser. No. 14/364,511 filed on Sep. 22, 2014, which is a national phase application of PCT/IB2011/055618 filed on Dec. 12, 2011, the entire contents of which are incorporated herein by reference.

### FIELD OF THE INVENTION

The present invention relates to the field of image processing, particularly to a system and method for estimating the size of an object in an image, specifically, when there is a high contrast difference between the object and the background in the image.

### BACKGROUND OF THE INVENTION

It is known that there are systems that use methods and models to estimate the position and size of an object in a still image or a video frame. Infrared search and track (IRST) systems, in which infrared images of a scene are acquired and converted into grayscale format, are good examples of such systems. The acquired images consist of a two-dimensional array of pixel values which represent infrared intensities at these locations. Currently there are some methods to estimate the location and the size of an object using statistical approaches. For example, there is one statistical approach including the steps of calculating the standard deviation of intensity values of neighboring pixels around a center pixel and successively decreasing the neighboring area until an object is detected. This statistical approach requires determination of an image histogram which is a distribution of pixels having different intensities. While this approach may be considered reasonable, in practice, some other steps are needed to make sure that the system doesn't get influenced by some factors, such as possible noises from a sensor, texture of the object or unexpected temperature changes in case of infrared vision, which makes the problem much more complex.

In another implementation, the position of the object is already known, a search for the object is thus unnecessary, and the primary objective is to determine the object size based on its pixel position. In this case, the position of the object can be provided by the user (e.g. selecting the position by a pointing device), and the object size is determined by searching for an object inside different windows (with all possible sizes). This is a very slow process, which depends on image resolution. In addition, a step of determining whether the system is being affected by noise/texture is also required, and this step is usually performed with a signal to noise ratio analysis, which is inefficient.

In another implementation, image gradient values are used to detect an object position. This method is very susceptible to image noises, and can only detect the object position. In order to detect the object size, a step of calculating pixel value standard deviations in an area around a given object position is required.

In order to solve the above-mentioned problems, methods that generate scale-spaces of images (the representation of images with different scales or magnifications) can be used. Scale-space based methods can handle issues caused by texture and/or noise and can detect the object size independent of the image resolution. There are some existing methods, using image scale-space to identify salient features on an object in an image. However, these methods are not aimed to estimate the object size and include complex convolution operations which are unnecessary for our purpose.

As a result, for a gray level image that includes an object at a given position, the existing methods fail to offer a simple and efficient way to estimate the size of a rectangle that encapsulates the whole object with minimum possible number of background pixels.

The United States patent US20110001823 discloses a method for detecting an object location and size, using a pixel standard deviation. The object size is obtained by varying window size by one pixel in each iteration.

The U.S. Pat. No. 7,430,303 discloses a method for detecting an object in an image using image gradient values, which are very sensitive to image noises.

The U.S. Pat. No. 6,711,293 discloses a method of detecting salient features on an image, and differences of Gaussians are used to construct a scale-space. This method identifies a list of salient points on the image.

### SUMMARY OF THE INVENTION

An objective of the present invention is to provide a method for estimating the size of an object in an image acquired by a sensor, with a selected pixel position on the object.

Another objective of the present invention is to provide a simple and efficient method for estimating the size of a rectangle that encapsulates the whole object with minimum possible number of background pixels, using scale space of pixel standard deviations.

Another objective of the present invention is to provide a method for estimating the object size independent of the resolution of an imaging system, which is used to capture the object.

The present invention generates a pixel standard deviation scale-space. In other words, while calculating the standard deviations in growing windows, the step size is increased in each iteration. Thus, the object size search is performed with successively increasing step sizes. In this way, the present invention can obtain the object size regardless of the image resolution.

Further, the present invention uses pixel standard deviations, which are robust with respect to image noises.

### BRIEF DESCRIPTION OF THE DRAWINGS

FIG. 1 is a flowchart of a first embodiment of a method of the present invention.

FIG. 2 is a graph showing a relationship between the standard deviation and the window size of a rectangular window enclosing a low-noise and low-texture object.

FIG. 3 is a flowchart of a second embodiment of a method of the present invention.

FIG. 4 is a flowchart of a third embodiment of a method of the present invention.

FIG. 5 is a schematic view of an embodiment of a system of the present invention.

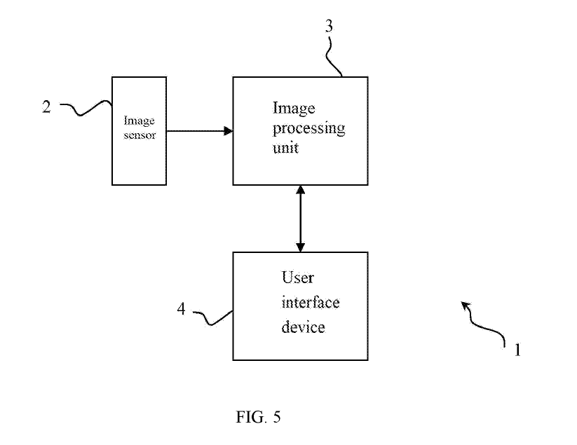

In FIG. 5, wherein the reference numbers are showed as below:

1. System for estimating object size; 2. Image sensor; 3. Image processing unit; 4. User interface device

### DETAILED DESCRIPTION OF THE INVENTION

Hereinafter, the invention will be explained in detail, with reference to the embodiments and accompanying drawings.

The invention is intended to estimate the size of an object shown in an image. In the image, there is a high contrast between the object and the background, while there is a low contrast among the background pixels and a low contrast among object pixels.

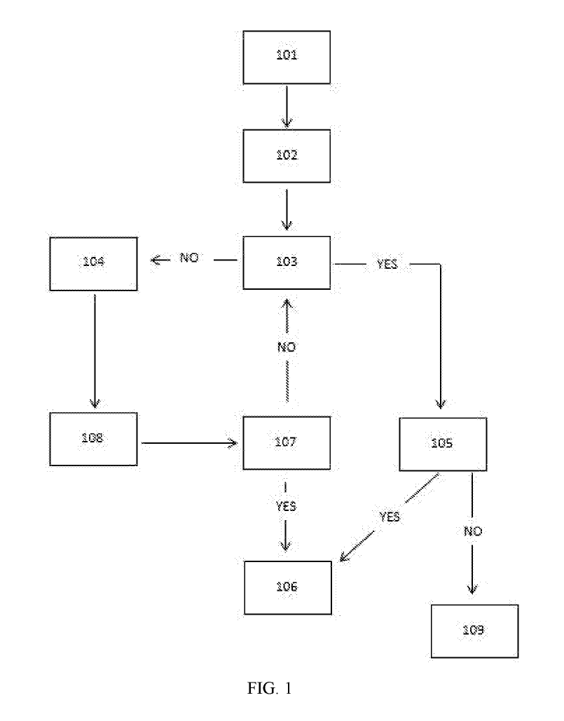

As shown in FIG. 1, in a first embodiment, a method for estimating the object size includes the following steps:

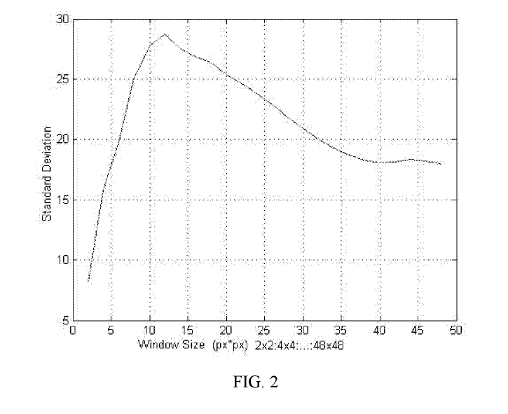

Step 101: providing a pixel image including at least one object and selecting a pixel on the object.
Step 102: calculating pixel standard deviations for pixels lying within an increasing window, to generate a graph of window size versus standard deviation. Specifically, the window has a predetermined initial window size, and is centered around the selected pixel on the object. The window is successively enlarged in at least one direction by a step-size from the predetermined initial window size up to a predetermined maximum window size, and pixel standard deviations for pixels lying within each successively enlarged window are respectively calculated. Accordingly, the graph of window size versus standard deviation is generated.
Step 103: checking whether the curve of the graph of window size versus standard deviation represents a monotonically decreasing trend or not.
If the curve of the graph does not represent a monotonically decreasing trend, for example, the curve of the graph shows a monotonically increasing trend, or the curve of the graph has a peak value (as shown in FIG. 2), then the following steps are performed:

Step 104: recording the window size corresponding to a pixel standard deviation value which is nearest to the right of the maximum pixel standard deviation value on the graph.

Step 108: generating a graph of window size versus standard deviation with an increased step size.

Step 107: checking whether the iteration number for querying the step 103 exceeds the predetermined iteration limit.
If the iteration number exceeds the predetermined iteration limit, then step 106 is performed: estimating the window size as the window size last recorded;
If the iteration number does not exceed the predetermined iteration limit, then step 103 is performed again: checking whether the graph with an increased step-size represents a monotonically decreasing function or not.
   If the curve of the graph represents a monotonically decreasing trend, then the following steps are performed:

Step 105: checking whether there is a previously recorded window size;
If there is a previously recorded window size, then step 106 is performed: estimating the object size as the window size last recorded;

If there is no previously recorded window size, then step 109 is performed: estimating the object size as the predetermined initial window size.

As to the step 101, a grey level image of the scene under consideration is received together with the coordinates of a pixel on the object on this image. Within an imaginary window that properly encloses the object, the standard deviation of the pixels in the window should be close to a maximum value of the standard deviation. In theory, for the standard deviation values calculated for different sized windows around the given pixel, the object size is equal to the window size that corresponds to the maximum pixel standard deviation. Therefore, the size of the imaginary window around the object, for which the pixel standard deviation is maximum, can be assumed as a good estimate for the window size that encapsulates the whole object with minimum possible number of background pixels, i.e. the object size.

As to step 102, pixel standard deviations around the given pixel on the object are calculated within growing rectangular windows having different window sizes. During this step, window size is increased in at least one direction. The enlargement in one direction is performed with a predefined step-size, starting from an initial window size. At the end, a graph of window size versus standard deviation is obtained.

For example, to estimate the size of a square or a circular object, a square window can be enlarged in both directions with the same step size. For an irregular shape (for instance, an ellipse), the enlargement can be performed in separate directions independently. Therefore, it is possible to find the change of standard deviation for different directions, thus the size of a non-symmetric shape can also be calculated. The rectangular window can be arbitrarily rotated about the object pixel coordinate, but this rotation should remain the same throughout a set of standard deviation calculations, in order to obtain the graph of window size versus standard deviation. Nevertheless, at the end of the step 102, if the image noise is not excessive and the object does not possess detailed texture (as applicable for infrared images), a graph of window size versus standard deviation similarly to the graph as shown in FIG. 2 may be obtained.

In all the iterations, one graph is generated for each iteration. The maximum value (the point where the standard deviation first starts to decrease) on the curve of the graph is searched and recorded. After this maximum value, the curve of the graph shows a monotonically decreasing trend. During the search of the graph having a peak value of standard deviation, the step-size (used to enlarge the window size for every standard deviation calculation) is increased at every iteration, i.e., the step-size of the next iteration is larger than the previous iteration. In other words, to obtain different graphs of window size versus standard deviation, the window size is enlarged with an increasing step-size. For example, if the windows sizes are 3×3; 5×5; 7×7 etc. for the first graph in the first iteration (step-size=2), then the windows sizes are 3×3; 7×7; 11×11 (step-size=4) for the second graph in the second iteration. This is similar to down-sampling the image for every iteration and provides a way to use a scale-space of pixel standard deviations. In this way, a more general view is obtained with successive iterations. When a graph having a peak value of standard deviation is generated, the window size corresponding to the point where the maximum standard deviation first starts to decrease would be a good estimate for the object size.

In another embodiment, the initial window size, which is used to generate the graph showing the relationship between the standard deviation and the increasing window size, is also increased proportional to the step-size in order to make it compatible with the higher scale levels. For example, if the windows sizes are ×3; 5×5; 7×7 etc. for the first graph in the first iteration (step-size=2), then the windows sizes are 5×5; 9×9; 13×13 (step-size=4) for the second graph in the second iteration.

The reason why a graph showing a monotonically decreasing trend is expected at a higher scale level (i.e., in a higher iteration), is due to the window size. With the increasing step-size and increasing initial window size, the updated window size may be large enough to encapsulate the considerable number of background pixels and the object. In this case, as the window size is further increased, the standard deviation decreases due to the fact that more and more background pixels will be included in the increasing window. Therefore, the graph having a peak value, succeeded by later graph showing a monotonically decreasing trend, can be used to estimate the object size. Such a search algorithm prevents the method from being misled by lower scale levels (iterations with small step-sizes).

A specific example is provided below to further explain the invention.

In this example, the iteration limit is 5, the maximum window size is 51×51, the step-size of the first iteration is 2, the predetermined initial window size is 3×3, and the step-size increment for each iteration is 4. σ represents the standard deviation in each window. The relationship between the window size and the standard deviation for each iteration is showed below.

Iteration 1: (step size 2)
3×3 window, σ=1.4
5×5 window, σ=1.7
7×7 window, σ=1.9
9×9 window, σ=2.1
11×11 window, σ=2.3

In this iteration, the maximum standard deviation value corresponds to 11×11 window. The curve of the first graph of window size versus standard deviation represents a monotonically increasing trend, i.e., the curve of the first graph does not represent a monotonically decreasing trend, and thus iteration 2 is continued to be performed.

Iteration 2: (step size 2+4)
7×7 window, σ=1.9
13×13 window, σ=2.4
19×19 window, σ=2.1
25×25 window, σ=1.9
31×31 window, σ=1.8

In this iteration, the maximum standard deviation value corresponds to 13×13 window, the window size 19×19 (the next window size after 13×13) is recorded. Since there is a peak value on this second graph of window size versus standard deviation, the curve of the second graph does not represent a monotonically decreasing trend, and thus iteration 3 is continued to be performed.

Iteration 3: (step size 2+4+4)
11×11 window σ=2.3
21×21 window σ=2.1
31×31 window σ=1.9
41×41 window σ=1.3
51×51 window σ=1.1

The curve of the third graph represents a monotonically decreasing trend, and thus iteration 4 would not be performed. The previously recorded window size 19×19 in the previous iteration 2 is estimated as the object size.

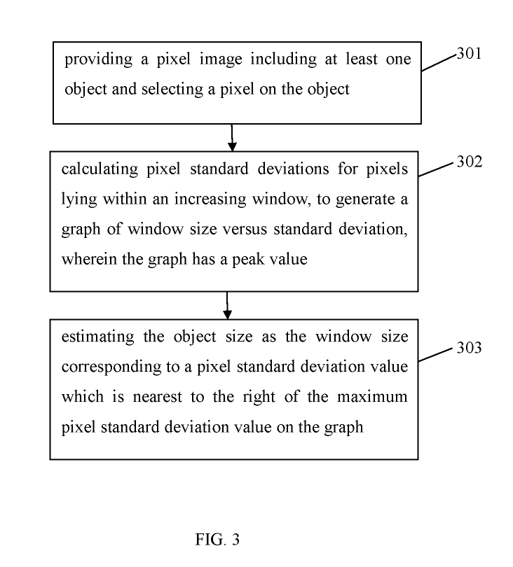

As shown in FIG. 3, in a second embodiment, a method for estimating the object size includes the following steps:

Step 301: providing a pixel image including at least one object and selecting a pixel on the object.
Step 302: calculating pixel standard deviations for pixels lying within an increasing window, to generate a graph of window size versus standard deviation, wherein the graph has a peak value. Specifically, the window has a predetermined initial window size, and is centered around the selected pixel on the object. The window is successively enlarged in at least one direction by a step-size from the predetermined initial window size up to a predetermined maximum window size, and pixel standard deviations for pixels lying within each successively enlarged window are respectively calculated. Accordingly, the graph of window size versus standard deviation is generated, and this graph, similarly to FIG. 2, has a peak value.
Step 303: estimating the object size as the window size corresponding to a pixel standard deviation value which is nearest to the right of the maximum pixel standard deviation value on the graph.

The second embodiment is applicable when the graph, more specifically, the first graph, has a peak value.

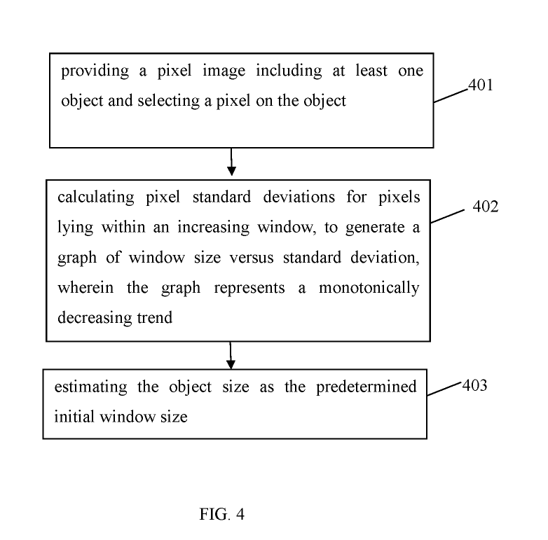

As shown in FIG. 4, in a third embodiment, a method for estimating the object size includes the following steps:

Step 401: providing a pixel image including at least one object and selecting a pixel on the object.

Step 402: calculating pixel standard deviations for pixels lying within an increasing window, to generate a graph of window size versus standard deviation, wherein the graph represents a monotonically decreasing trend. Specifically, the window has a predetermined initial window size, and is centered around the selected pixel on the object. The window is successively enlarged in at least one direction by a step-size from the predetermined initial window size up to a predetermined maximum window size, and pixel standard deviations for pixels lying within each successively enlarged window are respectively calculated. Accordingly, the graph of window size versus standard deviation is generated, and this graph represents a monotonically decreasing trend.

Step 403: estimating the object size as the predetermined initial window size.

For example, the predetermined initial window size is 3×3, then the object size can be estimated as 3×3. The third embodiment is applicable when the object size is very small.

In the fourth embodiment, after performing all the iterations, for example, 5 iterations, the five graphs of window size versus standard deviation all represents a monotonically increasing trend, then the object size is estimated as the predetermined maximum window size, for example, 51×51. The fourth embodiment is applicable when the object size is too large, or the step size is too small.

As shown in FIG. 5, the system 1 for estimating object size includes the following units;
at least one image sensor 2 to acquire at least one electronic pixel image of the scene under consideration;
at least one user interface device 4 configured to receive at least one coordinate of a point on the object from the user selection;
at least one image processing unit 3 configured to receive at least one image, and at least one coordinate of a pixel on the object, implement the method for estimating object size using these data; generate at least one rectangle around the object pixel, and show the rectangle on the user interface device 4. Wherein the size of the rectangle is decided by the method for estimating object size.

In a preferred embodiment of the present invention, image sensor 2 is a sensor configured to acquire an image with a high contrast between a possible object and its background. Preferentially image sensor 2 is an infrared vision camera which can differentiate temperature differences in the scene.

In a preferred embodiment of the present invention, user interface device 4 consists of a pointing device such as a mouse, joystick or similar device, configured to display a two-dimensional pixel image. User interface device 4 is configured to receive at least one coordinate from the user on the pixel image. The user selects a point on the object and the coordinate of the point is used in the method for estimating object size implemented on the image processing unit 3. The user can also reselect the point anytime to correct any mistake in the size estimation.

In a preferred embodiment of the present invention, image processing unit 3 is configured to receive at least one image from image sensor 2 and at least one coordinate of a pixel on the object from user interface device 4. In another preferred embodiment, at least one coordinate of the object is received continuously (or automatically at predetermined intervals) from an automatic object searching and tracking device and the image is received from a recorded or live image sequence (video stream). The one skilled in the image processing field should understand that this system 1 and the method for estimating object size can be applied on a sequence of pixel images, and the object size can be continuously monitored. Since the coordinate of a pixel (the position of the pixel) on the object is known, it is possible for user interface device 4 to generate at least one rectangle, having a size decided by the method for estimating object size, around the object, and show the rectangle on the display.

The image processing unit 3, also called “image processor”, is designed to support video and graphics processing functions and to interface with video and still image sensors and displays.

The image processing unit 3 is a specialized digital signal processor (DSP) used for image processing in digital cameras, mobile phones or other devices. To increase the system integration on embedded devices, the image processing unit 3 can be a system on a chip with multi-core processor architecture.

The method for estimating object size can effectively estimate the size of an object on a pixel image and display a “bounding box” around the object, given a position of a pixel on the object. A simple and efficient methodology used to estimate the size of a rectangle, which encapsulates the whole object with minimum possible number of background pixels using scale space of pixel standard deviations, is obtained. Moreover, the object size is estimated regardless of the visualization system's image resolution. The pixel resolution indicates how many pixels correspond to one meter of an object at a constant distance from the camera. When the image resolution of the visualization system changes, the number of pixels also changes. For instance, a method, which searches for a proper standard deviation value in a window increased by one pixel at each iteration, will function differently in a system with different resolutions. However, in our invention, if the pixel resolution of the visual system is changed, the curve of the graph having a peak value, succeeded by a monotonically decreasing trend will show up in a different iteration and give a different rectangular object size (in pixels); however, the rectangle will still encapsulate the whole object with minimum number of background pixels.

With the method performed by the image processing unit 3, the method can estimate the object size in a more efficient way. Specifically, the user only needs to select a pixel on the object, then a “bounding box” is showed around the object and the size of the “bounding box” is estimated as the object size. This method provides a simple and efficient methodology used to estimate the size of a rectangle, which encapsulates the whole object with minimum possible number of background pixels.

Within the scope of these basic concepts, it is possible to develop a wide variety of embodiments of the inventive system and method for estimating object size. The invention is not limited to the embodiments and examples described herein. The scope of the invention is defined by the appended claims.

I claim:

1. A method for estimating a size of an object in an image, the method being implemented on images captured and processed by an image processor for increasing the efficiency and quality of the estimation of an object size in the image, the method comprising:
step 101: providing a pixel image including at least one object and selecting a pixel on the object;
step 102: calculating pixel standard deviations for pixels lying within an increasing window, to generate a graph of window size versus standard deviation;
step 103: checking whether a curve of the graph of window size versus standard deviation represents a monotonically decreasing trend or not;
if the curve of the graph does not represent a monotonically decreasing trend, then following steps are performed,
step 104: recording a window size corresponding to a pixel standard deviation value which is nearest to the right of the maximum pixel standard deviation value on the graph,
step 108: generating another graph of window size versus standard deviation with an increased step size,
step 107: checking whether the iteration number for querying the step 103 exceeds a predetermined iteration limit,
if the iteration number exceeds the predetermined iteration limit, then estimating the window size as a window size last recorded;
if the iteration number does not exceed the predetermined iteration limit, then performing the step 103,
if the curve of the graph represents a monotonically decreasing trend, then following steps are performed,
step 105: checking whether there is a previously recorded window size;
if there is the previously recorded window size, then step 106 is performed, estimating the object size as the window size last recorded;
if there is no previously recorded window size, then step 109 is performed, estimating the object size as a predetermined initial window size.

2. The method for estimating a size of an object of claim 1, wherein in the step 102, the window has a predetermined initial window size, and is centered around a selected pixel on the object.

3. The method for estimating a size of an object of claim 2, wherein the window is successively enlarged in at least one direction by the step size from the predetermined initial window size up to a predetermined maximum window size.

4. The method for estimating a size of an object of claim 3, wherein in the step 108, in each iteration, the step size is increased by a predetermined value.

5. The method for estimating a size of an object of claim 4, wherein the step size is increased proportional to an increment of the predetermined initial window size.

6. The method for estimating a size of an object of claim 2, in the step 103, when the curve of the graph does not represent a monotonically decreasing trend, the curve of the graph shows a monotonically increasing trend, or the curve of the graph has a peak value.

7. A method for estimating a size of an object in an image, the method being implemented on images captured and processed by an image processor for increasing the efficiency and quality of the estimation of the size of the object in the image, the method comprising:
providing a pixel image including at least one object and selecting a pixel on the object;
calculating pixel standard deviations for pixels lying within an increasing window, to generate a graph of window size versus standard deviation, wherein the graph represents a monotonically decreasing trend;
estimating the object size as a predetermined initial window size.

8. The method for estimating a size of an object of claim 7, wherein the window has the predetermined initial window size, and is centered around a selected pixel on the object.

9. The method for estimating a size of an object of claim 8, wherein the window is successively enlarged in at least one direction by a step size from the predetermined initial window size up to a predetermined maximum window size.

10. A system for estimating a size of an object, comprising:
at least one image sensor to acquire at least one electronic pixel image;
at least one user interface device configured to receive at least one coordinate of a point on the object from a user selection;
at least one image processing unit configured to perform a method for estimating a size of an object, comprising following steps:
step 101: providing a pixel image including at least one object and selecting a pixel on the object;
step 102: calculating pixel standard deviations for pixels lying within an increasing window, to generate a graph of window size versus standard deviation;
step 103: checking whether a curve of the graph of window size versus standard deviation represents a monotonically decreasing trend or not;
if the curve of the graph does not represent a monotonically decreasing trend, then following steps are performed,
step 104: recording a window size corresponding to a pixel standard deviation value which is nearest to the right of the maximum pixel standard deviation value on the graph,
step 108: generating another graph of window size versus standard deviation with an increased step size,
step 107: checking whether the iteration number for querying the step 103 exceeds a predetermined iteration limit,
if the iteration number exceeds the predetermined iteration limit, then estimating the window size as a window size last recorded;
if the iteration number does not exceed the predetermined iteration limit, then performing the step 103,
if the curve of the graph represents a monotonically decreasing trend, then following steps are performed,
step 105: checking whether there is a previously recorded window size;
if there is the previously recorded window size, then step 106 is performed, estimating the object size as the window size last recorded;
if there is no previously recorded window size, then step 109 is performed, estimating the object size as a predetermined initial window size.

11. The system for estimating a size of an object of claim 10, wherein in the step 102, the window has the predetermined initial window size, and is centered around a selected pixel on the object.

12. The system for estimating a size of an object of claim 11, wherein the window is successively enlarged in at least one direction by the step size from the predetermined initial window size up to a predetermined maximum window size.

13. The system for estimating a size of an object of claim 12, wherein in the step 108, in each iteration, the step size is increased by a predetermined value.

14. The system for estimating a size of an object of claim 13, wherein the step size is increased proportional to an increment of the predetermined initial window size.

15. The system for estimating a size of an object of claim 14, in the step 103, when the curve of the graph does not represent a monotonically decreasing trend, the curve of the graph shows a monotonically increasing trend, or the curve of the graph has a peak value.
